(19) United States
(12) Patent Application Publication
(10) Pub. No.: US 2010/0108319 A1
(43) Pub. Date: May 6, 2010

(54) Reduced Waste Cleaning Methods for Oil Well Related Systems

(75) Inventors: Glynn M. Hollier, The Woodlands, TX (US); Davis G. Fontenot, Kingwood, TX (US)

Correspondence Address: Mossman, Kumar and Tyler, PC, P.O. Box 421239, Houston, TX, 77242, US

(73) Assignee: Baker Hughes Incorporated, Houston, TX (US)

(21) Appl. No.: 12/582,184

(22) Filed: Oct. 20, 2009

Related U.S. Application Data
(60) Provisional application No. 61/110,327, filed on Oct. 31, 2008.

(51) Int. Cl. E21B 43/26; E21B 43/25; E21B 7/00; G05D 11/00; B08B 9/00

(52) U.S. Cl. 166/308.1; 166/305.1; 175/57; 137/3; 134/166 R; 134/22.1

(57) ABSTRACT

A method for using an engineered fluid in a manner that reduces or minimizes waste includes applying the engineered fluid to a container having a settled component of a stored fluid, retrieving the applied engineered fluid and at least a portion of the settled component from the container, and using the applied engineered fluid at least once in the same manner as the stored fluid was used. In certain applications, the applied engineered fluid may be put to a different use. The engineered fluid may be processed prior to use.

### CROSS-REFERENCE TO RELATED APPLICATIONS

This application claims benefit of and takes priority from U.S. Provisional Application Ser. No. 61/110,327 filed Oct. 31, 2008, which is incorporated herein by reference.

### FIELD OF THE DISCLOSURE

1. Field of the Disclosure

This disclosure relates to the cleaning of containers used for storing engineered fluids.

2. Background of the Disclosure

The construction, completion, and workover of hydrocarbon producing wells, often requires a variety of engineered fluids. During drilling of a wellbore, drilling fluids or “muds” may be used to provide well bore lubrication, to cool the drill bit, to protect against corrosion and to provide a pressure head to maintain formation integrity. Later, during completion operations, frac fluids may be utilized to increase the flow out of subsurface formations. Drilling fluids and frac fluids are merely illustrative of the various fluid that may need to be transported, stored, utilized, and recovered during well construction or completion.

In many instances, the engineered fluids used in these applications include a carrier fluid and an entrained component. For example, a frac fluid may include diesel and sand. Also, a drilling fluid may include water or oil and entrained solids. During use, these engineered fluids may be stored in tanks, pits, and other enclosed or open spaces that will hereafter be referred to as containers. In some instances, these fluids may remain stored for a period sufficient for the entrained material to settle from the carrier fluid.

Conventionally, human personnel utilize pressurized water to clean the settled entrained material from the surfaces of the containers. Thereafter, the water, together with the settled entrained material, is disposed of in a suitable manner. The present disclosure provides methods and devices for cleaning such containers while reducing the amount of material that is wasted.

### SUMMARY OF THE DISCLOSURE

In aspects, the present disclosure provides a method for using an engineered fluid in a manner that reduces or minimizes waste. In one embodiment, the method includes applying the engineered fluid to a container having a settled component of a stored fluid. The stored fluid and the engineered fluid may have the same or similar formulation; e.g., the same carrier liquid and suspended component. After application of the engineered fluid, the applied engineered fluid and at least a portion of the settled component are retrieved from the container and the applied engineered fluid may be used at least once in the same manner as the stored fluid was used. The applied engineered fluid may be processed prior to use. In variants, the stored fluid is a drilling fluid, and the method may include circulating the applied engineered fluid into a wellbore. In arrangements, a hydraulically powered remote controlled nozzle may be used to apply the engineered fluid to the container. The processing may include one or more steps, including adding a component to the applied engineered fluid and/or mixing the applied engineered fluid to suspend the settled component in applied engineered fluid. The method may be used with any engineered fluid, including fluids used for fracturing a formation; treating a formation, or cooling and lubricating a drill bit.

In aspects, the present disclosure provides also provides a system for cleaning a container having a settled component of a stored fluid. The system may include a source of an engineered fluid; and an applicator that receives the engineered fluid from the source and applies the engineered fluid to the container. In arrangements, the applicator may apply the engineered fluid at a velocity sufficient to dislodge at least some of the settled component from the container. The stored fluid and the engineered fluid may both be a drilling fluid. Also, the stored fluid and the engineered fluid may both used to fracture a formation or treat a formation. In some arrangements, the applicator may include a hydraulically powered remote controlled nozzle. In some embodiments, the system may further include a processor that receives the applied engineered fluid and adds a second component to the applied engineered fluid. Alternatively or additionally, the processor may mix the applied engineered fluid to suspend the settled component in applied engineered fluid.

In aspects, the present disclosure provides further provides a method for producing a working fluid for use in a wellbore. The method may include preparing an engineered fluid; applying the engineered fluid to a container to dislodge a component of a stored fluid that has settled on a surface of the container; and processing the applied engineered fluid to form the working fluid. The stored fluid and the applied engineered fluid may both be compatible drilling fluids. The method may include adding a second component to the engineered fluid during processing and/or mixing the engineered fluid to suspend the settled component during processing. Also, the processed applied engineered fluid may be formulated to perform an activity such as fracturing a formation, treating a formation, or cooling and lubricating a drill bit.

Examples of the more important features of the disclosure have been summarized (albeit rather broadly) in order that the detailed description thereof that follows may be better understood and in order that the contributions they represent to the art may be appreciated. There are, of course, additional features of the disclosure that will be described hereinafter and which will form the subject of the claims appended hereto.

### BRIEF DESCRIPTION OF THE FIGURES

For detailed understanding of the present disclosure, reference should be made to the following detailed description of the preferred embodiment, taken in conjunction with the accompanying drawing:

FIG. 1 schematically illustrates an offshore drilling facility that utilizes containers that may be cleaned using embodiments of the present disclosure;

FIG. 2 schematically illustrates a remotely operable cleaning system that may be used in connection with the cleaning methods in accordance with embodiments of the present disclosure; and

FIG. 3 schematically illustrates a completed oil well that may utilize containers that may be cleaned using embodiments of the present disclosure.

### DETAILED DESCRIPTION OF THE DISCLOSURE

The present disclosure related to methods and devices for efficiently cleaning containers used for storing engineered fluids. For the purposes of the present disclosure, an engineered fluid may include a base or carrier fluid and an entrained secondary component that may precipitate or settle out of the carrier fluid. Also, in aspects, an engineered fluid may further have a characteristic that a settled component may be re-mixed, re-suspended or re-entrained into the carrier fluid. Illustrative, but not limiting, examples of engineered fluids include drilling fluids, lost circulation material (LCM), frac fluids, and brines. These fluids may be liquids, liquid mixtures or other fluid-like materials such as gels or slurries. The present disclosure is susceptible to embodiments of different forms. The drawings show and the written specification describes specific embodiments of the present disclosure with the understanding that the present disclosure is to be considered an exemplification of the principles of the disclosure, and is not intended to limit the disclosure to that illustrated and described herein.

In one embodiment, a method for cleaning a container that has one or more surface coated or lined with a component that has settled from a stored engineered fluid includes applying to such surfaces a pressurized stream of a fluid that is chemically the same or similar to the previously stored engineering fluid. The component may be a solid, a semi-solid, a natural material, or a human-made material. The composition of the applied cleaning fluid is selected such that the settled components that are dislodged from the surfaces are re-entrained or suspended into the applied fluid. The processing may include mixing, heating, cooling, changing the ratio of carrier fluid and components, adding a secondary component, removing contaminants, etc. In certain embodiments, the applied cleaning fluid and dislodged settled components may require additional processing. Thereafter, the applied fluid may be used in the same or similar manner as the stored engineered fluid. Thus, rather than being disposed of, the applied cleaning fluid is put to productive, non-wasteful use. In embodiments, the use is the same use to which the previously stored fluid was put.

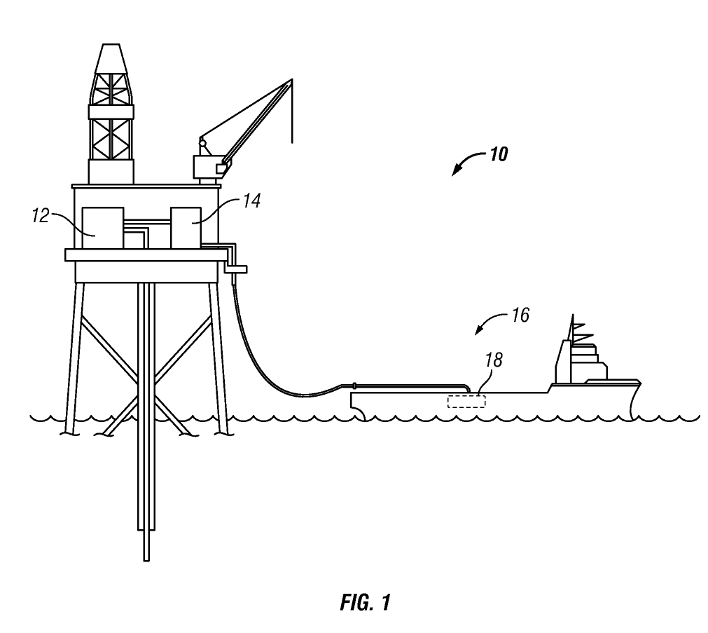

Referring now to FIG. 1, there is shown an offshore drilling rig 10 for drilling subsea wellbores. A prevalent engineered fluid that is frequently used in subsea drilling operations conducted from the rig 10 is drilling fluid or “drilling mud.” As used herein, the term drilling fluid is a water-based or oil-based liquid that includes entrained solids. The oil-based liquid may be diesel or synthetic oil. Typically, the drilling fluid is circulated in a fluid circulation system that includes one or more pump units 12, a drilling fluid supply 14, and a cuttings processing system (not shown). The drilling fluid is circulated to accomplish an number of tasks, including, but not limited to, cool and lubricate a drill bit (not shown), remove cuttings and debris from the wellbore (not shown), and apply pressure to the formation. The drilling fluid may be transported to and from the rig 10 with a transport vessel 16 such as a barge or boat. The barge or boat 16 may have its own storage tanks 18. The transport vessel 16 may be utilized to ship the drilling fluid to the rig 10 before drilling and to retrieve the drilling fluid after drilling is completed.

As should be appreciated, the drilling fluid may be stored in several different containers during transportation to and from the rig 10 and while at the rig 10. Each of these storage containers (e.g., the drilling fluid supply 14 and the barge or boat storage tanks 18) may require periodic cleaning to remove sediment, i.e., the entrained solids that have settled out of the carrier fluid. To clean such containers, the composition of the cleaning fluid is first selected to provide a usable fluid after being mixed with the sediment in the containers. For example, if a synthetic oil mud was stored in the container, then the cleaning fluid may include a similar synthetic oil mud. If a diesel-based mud was stored in the container, then the cleaning fluid may include a similarly formulated diesel fuel mud. Likewise, if a water-based oil mud was stored in the container, then the cleaning fluid may include water. The cleaning fluid may also include specified amounts of entrained components. After appropriately formulating the cleaning fluid, the cleaning fluid is applied to the surfaces of the storage containers. In embodiments, the cleaning fluid is pressurized to generate a sufficiently high fluid velocity to scrub the surfaces and to dislodge the settled solids. The cleaning fluid and the dislodged settled solids are circulated from the container and conveyed to a facility for further processing to bring the cleaning fluid into a usable state. Thus, rather than being discarded as waste, the cleaning fluid is converted or transformed into an engineered fluid that may be put the same uses as the engineered fluids that were stored in the cleaned containers. For instance, if the drilling fluid stored in the containers was circulated into a wellbore, then the cleaning fluid used to clean the containers may be circulated into the wellbore.

It should be understood that drilling fluids are only illustrative of the type of engineered fluids that can be utilized in connection with the present disclosure. Another illustrative engineered fluid is lost circulation material (LCM). The LCM usually includes particles that plug and seal the fractured or weak formation. In some instances, drilling fluid may be lost to a weak or fractured formation. LCM sometimes is circulated into the well to strengthen the formation and reduce the loss of drilling fluid. Thus, the containers used to store LCM may be cleaned using an LCM, or a variant of an LCM. Thereafter, the LCM used to clean the containers may be pumped into a wellbore as needed.

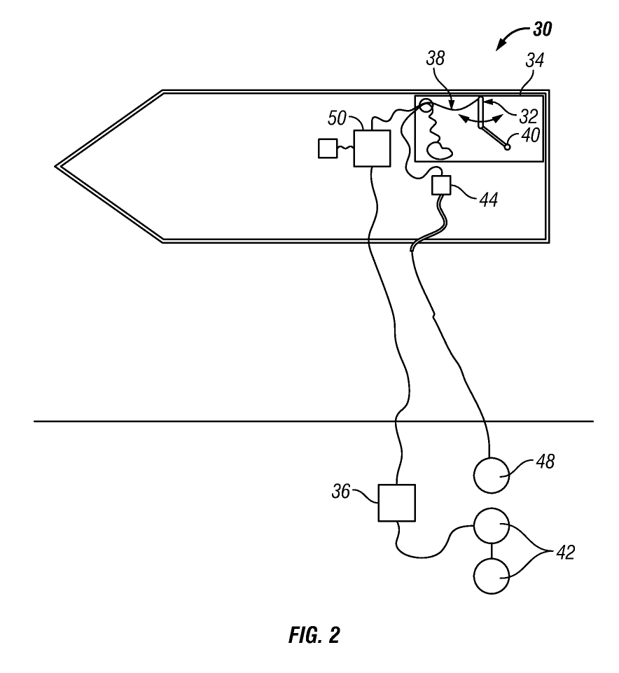

In embodiments, the cleaning fluid may be applied with a remotely operated cleaning device. Once suitable device is disclosed in U.S. Pat. Nos. 7,261,109 and 7,320,329, which are commonly owned, and which are incorporated by reference for all purposes. Referring now to FIG. 2, a suitable remotely operated cleaning device 30 may include at least one arm assembly 32 adapted to be mounted on an interior surface of an enclosed area, for example mud tank 34. A supply pump 36, supplies a cleaning fluid at relatively high rate and pressure through hose 38 to the arm assembly 32, and ultimately to the nozzle 40. The supply pump 36 may comprise any pump capable of generating a pressure differential of sufficient magnitude to propel the cleaning fluid out of the nozzle 40 with sufficient velocity to dislodge the settled components. Supply pump 36 can supply any type of fluid or media such as water, recycled water, frac fluids, acids, drilling mud or chemicals, for example from supply tanks 42. While many different types of pumps may suffice, and can range in pressure and rate capability, an exemplary supply pump is a motorized centrifugal or positive displacement pump that can achieve high pressure and volumes. Ultra high pressure and large volume pumps along with pumps designed to pump heavy mud products may also be used. The cleaning fluids and dislodged components in the tank may be removed by a suitable suction or vacuum device 44. The removed cleaning fluid and dislodged components are then conveyed to a transport vessel or another storage tank 48. Rather than being disposed of, the removed cleaning fluid and dislodged components are taken to a processing facility, if needed, to be put into a condition for further use. A human operator may utilize a control unit 50 to control the arm assembly 32. The arm assembly 32 may use electrical, pneumatic, or hydraulic actuators for movement.

Because the remotely operated cleaning device 30 utilizes mechanical components and machine-generated power, the nozzle 40 can deliver fluids at higher velocities than what would be possible if a human operator were to manually manipulate the nozzle. Furthermore, the mechanical components may be configured to convey and apply relatively dense fluids at relatively high velocities, which may not be possible using primarily human power. Thus, the utilization of the remotely operating cleaning device 30 allows the use of a cleaning fluid that is the same as or similar to the engineered fluid that had been stored in a container.

The teachings of the present disclosure may also be used in other phases of wellbore construction and completion.

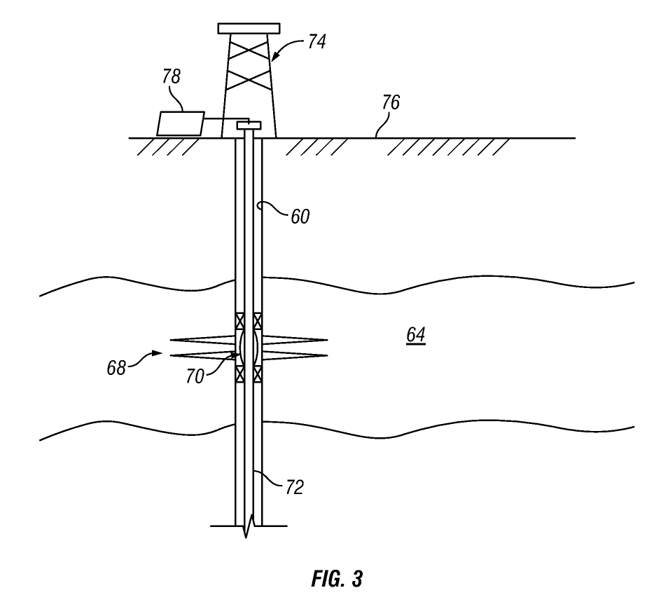

Referring initially to FIG. 3, there is shown an exemplary wellbore 60 that has been drilled through the earth and into a formation 64 from which it is desired to produce hydrocarbons. The wellbore 60 is cased by metal casing, as is known in the art, and a number of perforations 68 penetrate and extend into the formation 64 so that production fluids may flow from the formation 64 into the wellbore 60. The wellbore 60 has a late-stage production assembly, generally indicated at 70, disposed therein by a tubing string 72 that extends downwardly from a wellhead 74 at the surface 76 of the wellbore 60. In certain instances, it may be desirable to stimulate or otherwise treat the formation 64. One illustrative treatment is the use of “frac fluids.” A frac fluid include a liquid carrier and entrained solids such as sand. From one or more container 78 at the surface, the frac fluid is pumped into the wellbore 60 and into one or more formation 64. Relatively high fluid pressure is used to fracture the earth and rock of the formation. These fractures are kept open by the proppants, e.g., sand particles, that are suspended in the carrier liquid. Thus, the containers used for storing frac fluids may also be cleaned using the methodologies described above. The container 78 may be cleaned with a frac fluid, or a variant of a frac fluid, and also be pumped into the wellbore 60 to fracture the same or a different formation. Also, the frac fluid used to clean the container 78 may transported to a different well for use.

From the above, it should be appreciated that what has been described, in part, includes a method for using an engineered fluid in a manner that reduces or minimizes waste. The method may include applying the engineered fluid to a container having one or more settled components of a stored fluid. The stored fluid and the engineered fluid may have the same or similar formulation; e.g., the same carrier liquid and suspended component. After application of the engineered fluid, the applied engineered fluid and at least a portion of the settled component are retrieved from the container and the applied engineered fluid may be used at least once in the same manner as the stored fluid was used. The applied engineered fluid may be processed prior to use. In variants, the stored fluid is a drilling fluid, and the method may include circulating the applied engineered fluid into a wellbore. In arrangements, a remotely controlled nozzle may be used to apply the engineered fluid to the container. The processing may include one or more steps, including adding a component to the applied engineered fluid and/or mixing the applied engineered fluid to suspend the settled component in applied engineered fluid. The method may be used with any engineered fluid, including fluids used for fracturing a formation; treating a formation, or cooling and lubricating a drill bit.

From the above, it should be appreciated that what has been described, in part, also includes a system for cleaning a container having a settled component of a stored fluid. The system may include a source of an engineered fluid; and an applicator that receives the engineered fluid from the source and applies the engineered fluid to the container. In arrangements, the applicator may apply the engineered fluid at a velocity sufficient to dislodge at least some of the settled component from the container. The stored fluid and the engineered fluid may both be a drilling fluid. Also, the stored fluid and the engineered fluid may both used to fracture a formation or treat a formation. In some arrangements, the applicator may include a remotely controlled nozzle. In some embodiments, the system may further include a processor that receives the applied engineered fluid and adds a second component to the applied engineered fluid. Alternatively or additionally, the processor may mix the applied engineered fluid to suspend the settled component in applied engineered fluid.

From the above, it should be appreciated that what has been described, in part, may further include a method for producing a working fluid for use in a wellbore. The method may include preparing an engineered fluid; applying the engineered fluid to a container to dislodge a component of a stored fluid that has settled on a surface of the container; and processing the applied engineered fluid to form the working fluid. The stored fluid and the applied engineered fluid may both be drilling fluids. The method may include adding a second component to the engineered fluid during processing and/or mixing the engineered fluid to suspend the settled component during processing. Also, the processed applied engineered fluid may be formulated to perform an activity such as fracturing a formation, treating a formation, or cooling and lubricating a drill bit.

While the foregoing disclosure is directed to the preferred embodiments of the disclosure, various modifications will be apparent to those skilled in the art. It is intended that all variations within the scope of the appended claims be embraced by the foregoing disclosure.

What is claimed is:

1. A method for using an engineered fluid applied to a container having a settled component of a stored fluid, comprising:
using the engineered fluid at least once in substantially the same manner as the stored fluid was used.

2. The method of claim 1 wherein the stored fluid is a drilling fluid, and wherein the using includes circulating the applied engineered fluid into a wellbore.

3. The method of claim 1 further comprising applying the engineered fluid to a surface of the container at a velocity sufficient to dislodge at least some of the settled component.

4. The method of claim 3 further comprising using a remotely controlled nozzle to apply the engineered fluid to the container.

5. The method of claim 1 further comprising adding a second component to the engineered fluid after the engineered fluid is applied to the container.

6. The method of claim 1 further comprising mixing the engineered fluid to suspend the settled component in applied engineered fluid.

7. The method of claim 1 further comprising using the stored fluid to perform an activity selected from a group consisting of: (i) fracture a formation; (ii) treat a formation, and (iii) cool and lubricate a drill bit.

8. The method of claim 1 further comprising storing the stored fluid in the container for a time sufficient for the settled component to precipitate from the stored fluid.

9. A system for cleaning a container having a settled component of a stored fluid, comprising:
a source of an engineered fluid; and
an applicator configured to receive the engineered fluid from the source and further configured to apply the engineered fluid to the container,

10. The system of claim 9 wherein the applicator is configured to apply the engineered fluid at a velocity sufficient to dislodge at least some of the settled component from the container.

11. The system of claim 9 wherein the stored fluid and the engineered fluid are both a drilling fluid.

12. The system of claim 9 wherein the stored fluid and the engineered fluid are both used to one of: (i) fracture a formation; and (ii) treat a formation.

13. The system of claim 9 wherein the applicator includes a remotely controlled nozzle.

14. The system of claim 9 further comprising a processor configured to receive the applied engineered fluid and to add a second component to the applied engineered fluid.

15. The system of claim 9 further comprising a processor configured to receive the applied engineered fluid and to mix the applied engineered fluid to suspend the settled component in applied engineered fluid.

16. A method for producing a working fluid for use in a wellbore, comprising:
preparing an engineered fluid;
applying the engineered fluid to a container to dislodge a component of a stored fluid that has settled on a surface of the container; and
processing the applied engineered fluid to form the working fluid.

17. The method of claim 16 wherein the stored fluid and the applied engineered fluid are both drilling fluids.

18. The method of claim 16 further comprising adding a second component to the engineered fluid during processing.

19. The method of claim 16 further comprising mixing the engineered fluid to suspend the settled component during processing.

20. The method of claim 16 wherein the processed applied engineered fluid is formulated to perform an activity selected from a group consisting of: (i) fracture a formation; (ii) treat a formation, and (iii) cool and lubricate a drill bit.
